(19) United States
(12) Patent Application Publication
(10) Pub. No.: US 2002/0159224 A1
(43) Pub. Date: Oct. 31, 2002

(54) Electronic information retrieval device and process therefor

(76) Inventor: Illi Eisner, Port Washington, NY (US)

Correspondence Address: WILLIAM COLLARD, COLLARD & ROE, P.C., 1077 NORTHERN BOULEVARD, ROSLYN, NY, 11576, US

(21) Appl. No.: 09/979,777

(22) PCT Filed: Mar. 28, 2001
(86) PCT No.: PCT/US01/09935

(51) Int. Cl. H02B 1/00

(52) U.S. Cl. 361/600

(57) ABSTRACT

An electronic information retrieval device for retrieving information sent from a computer. The device comprises a display for displaying information sent from the computer, an interface connected to the display and a cable connected to the interface. This interface comprises a switch pad interface, a cable that will be hard wired and a power input. The cable connects the interface to the computer. In this case, the computer sends information to the interface and the interface sends this information to the display so that this information is displayed on the display. This display could be housed in a L-shaped housing having a counter weight comprising a bar and a base. The display could then be placed either on an edge of a substantially horizontal surface or on top of this substantially horizontal surface.

This application is a continuation in part application of U.S. patent application Ser. No. 09/536,543 filed on Mar. 28, 2000.

### BACKGROUND OF THE INVENTION

### FIELD OF THE INVENTION

The invention relates to an electronic information retrieval device for retrieving information sent from a computer. This information retrieval device is designed to display news, stock quotes and weather information, sports information and pager information.

### SUMMARY OF THE INVENTION

An electronic information retrieval device and a computer program form a system for retrieving electronic information over a computer network such as the Internet. The device comprises a display for displaying information sent from the computer, an interface connected to the display and a cable connected to the interface. This interface comprises a plurality of switches, a cable, a processor, and a power input or connection. In this case, the computer sends information to the interface and the interface sends this information to the display so that the information is shown scrolling across in an endless loop on the display while being continuously updated with information sent from the computer.

The switches include the following: a top line-change switch, a bottom line change switch, a switch for increasing the flow of information and a switch for decreasing the flow of information and an on/off switch. All of these switches are backlit so that they are easily readable by a user. These switches are designed to adjust the display on the display device.

This information display device is designed to display, among others, stock information, general news, financial news, commentaries, weather, sports news such as headlines and scores, and personal messages. In this case, all news, stock information including financial news, and commentaries, are downloaded through the Internet. A user selects this type of 4Information either through his or her homepage specifications or through an online request via e-mail. Once this information has been selected, a user can change the type of information shown on the display by using the switches. The switches scroll through and select different strings of information sent over the computer network to the display.

This display can be housed in a substantially L shaped housing. This substantially L-shaped housing could be used to place the display on an edge of a substantially horizontal surface to project a viewing angle for the display in a substantially horizontal manner, or on top of a substantially horizontal surface to point the viewing angle of the display up. In addition there could also be included a counter weight that comprises a base and a bar with the bar rotatably coupled to the housing. The base also includes a corrugated bottom grip surface to provide further stability to the display when it is placed either on an edge of the horizontal surface or on top of the horizontal surface.

If the display is placed on top of the substantially horizontal surface, then the viewing angle of this display can be adjusted by rotating the bar within the housing to adjust the angle of intersection between the counterweight and the housing. By rotating this bar, a user could control the pitch of the upward angle off of this horizontal surface. Thus, with this design, the user could then adjust this display to better view the information displayed on this display.

### BRIEF DESCRIPTION OF THE DRAWINGS

Other objects and features of the present invention will become apparent from the following detailed description considered in connection with the accompanying drawings, which disclose several embodiments of the present invention. It should be understood, however, that the drawings are designed for the purpose of illustration only and not as a definition of the limits of the invention.

In the drawings wherein similar reference characters denote similar elements throughout the several views:

FIG. 1 shows a block diagram of the device for retrieving and displaying information;

FIG. 2 shows a block diagram of a second embodiment of the device for displaying information;

FIG. 3 shows a flow chart that represents the flow of information from different pieces of hardware connected in a computer network;

FIG. 4 is a flow chart that represents the process that the program flows through to deliver information to the device;

FIG. 5 is a flow chart that represents the process for the control of information across a top line on the display;

FIG. 6 is a flow chart that represents the process for the control of information across a bottom line on the display.

FIG. 7 is a side view of the device showing its L-shaped profile;

FIG. 8 is a front view of the device;

FIG. 9 is a side cross-sectional view of the device;

FIG. 10 is an exploded front perspective view of the device; and

FIG. 11 is an exploded back perspective view of the device.

### DETAILED DESCRIPTION OF THE PREFERRED EMBODIMENT

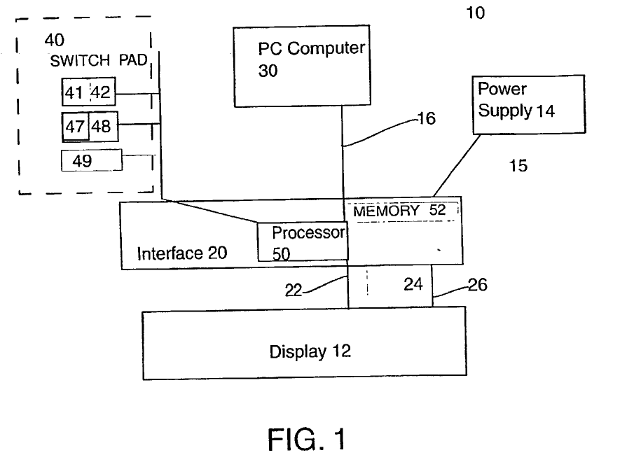

FIG. 1 refers to a schematic diagram for the hardware configuration of the invention showing an electronic information retrieval device 10. In this case, the information retrieval device comprises a display screen 12 which is preferably a LCD display, having a back light power input 14 that powers both the back light and the LCD itself. Display screen 12 is designed to show at least one line of a stock ticker a news retrieval service or any other text message. The display area is rectangular in shape and is approximately 155.1 mm long by 16.5 mm high. This display screen is designed to display up to 80 characters in one screen with up to 40 characters on each line. However, this display screen could be made larger or smaller depending upon the manufacturer's desired specifications.

With a display screen of this size, the size of each character is approximately 3.2 millimeters (mm) by 5.55 mm not including an underline. In addition, the character pitch is approximately 3.7 mm while the line pitch is approximately 5.95 mm. Furthermore, the dot size is approximately 0.6 by 0.65 mm, while the dot pitch is approximately 0.65 by 7 mm. Display screen 12 has a back light life of 100,000 hours, while preferably illuminating the characters in a yellow green tint.

Display screen 12 is connected to an interface 20 preferably a serial interface by a series of pins such as a 14-pin data transmission line 22, a ground pin 24, and a 5-volt power supply pin 26. One of the pins in the 14-pin data transmission line also feeds the LCD power. In addition the 5-volt power supply pin 26 powers the back light. The supply voltage fed through 5 volt power supply pin 26 could vary between 4.75 volts and 5.25 volts during use. In addition, the supply current that is fed into display screen 12 across data transmission line 22 is approximately 10 mA while the back light power supply current fed across 5 volt power supply pin 26 is approximately 90 mA. In use the voltage could fall to as low as 3 volts, however, this would result in a dimming of the back light display and text.

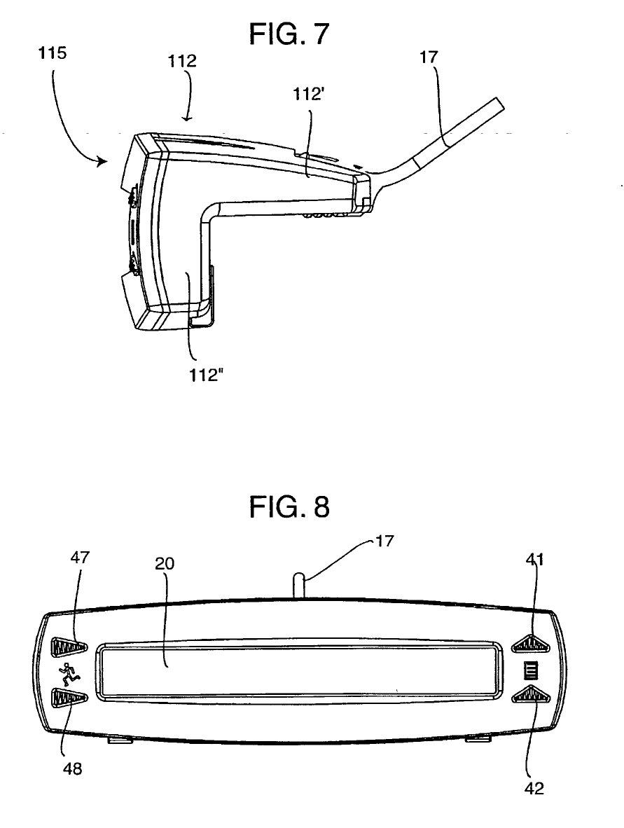

There are essentially two lines that feed into interface 20. A power supply line 15, and an information cable 16 disposed within a serial cable 17 shown in FIG. 7. Serial cable 17 containing power supply line 15 connects serial interface 20 to a wall outlet, or any other conventional power source such as batteries, or another power supply. Cable 16 is preferably a standard 9 pin information based serial cable that connects to computer 30 to receive information in the form of serial signals from computer 30.

The switch pad 40 is designed to contain a series of switches, however other designs could be used as well. In a preferred embodiment, there are only four switches necessary for the control of the display. For example, there is a top line change switch 41, a bottom line change switch 42, a switch for increasing the flow of displayed information 47 and a switch for decreasing the flow of displayed information 48. There is also an on/off power switch 49 which turns the device on and off. These switches are backlit so that they are easy to see when a room is dark. Other switches could be used in this design, however this preferred embodiment uses only a minimal number of switches necessary to operate this display. Switches 47 and 48 provide a significant benefit to the user because this allows the user to pause and review information that might be critical to that user as the information is flowing across display screen 12. Alternatively, if this information is not critical, it allows the user to increase the flow of information across display screen 12 so that the user does not waste time reviewing unimportant information.

Interface 20 contains a processor 50 for processing the information sent from the at least one switch pad 40 to control display screen 12. In addition, processor 50 also translates the serial signal sent from PC computer 30 over a line 16 into a signal for viewing on display screen 12. Line 16 could be any type line but is preferably a 9 pin serial line, while interface 20 is preferably a serial interface. This serial interface 20 contains memory 52 for storing the default baud rate for the interface but it does not contain any memory devices such as a hard drive or flash memory. Therefore, the information received into processor 50 is immediately processed, displayed, and then disposed. This LCD display will continue to display the information until it is either updated or cleared. For example, all groups of information or data are sent from PC computer 30 to display screen 12 in a series of repeating strings that continuously scroll across display screen 12 without being stored on device 10. This allows device 10 to be designed relatively simply and inexpensively.

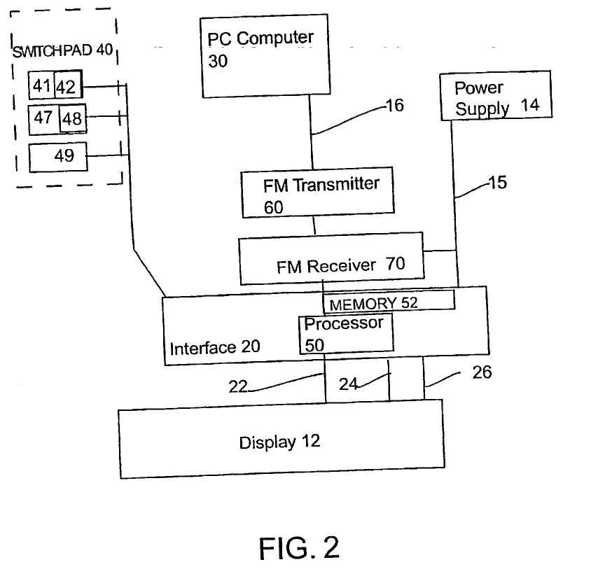

The second embodiment of the invention is shown in FIG. 2 and includes an additional FM transmitter 60 connected to serial cable 16, while interface 20 connects to a FM receiver 70 for receiving signals sent from FM transmitter 60. FM transmitter 60 converts the signal into a 2.4 Ghz frequency FM signal. The FM signal is then picked up by receiver 70, and then converted back into a serial signal. Both transmitter 60 and receiver 70 are industry standard products.

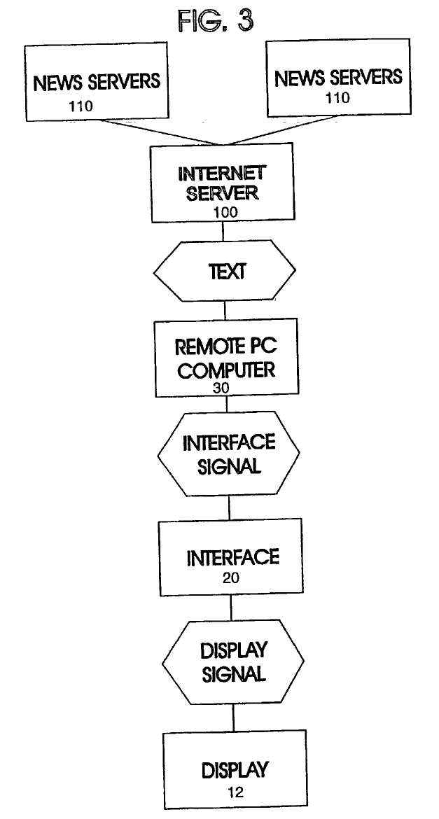

This transfer of information is shown in FIG. 3 wherein there is a flow chart shown representing the downloading of information from the Internet to device 10.

For example, information server 100 receives information from a subscription or free news service disposed on news servers 110. This information is stored in a database on information server 100. Next, through a series of CGI scripts, this information is selected from this database, particularized for each user, and sent to remote PC computer 30 in the form of ASCII delimited text.

To reduce the amount of information sent from server 100 to device 10, PC 30 only selects a limited amount of information from server 100. When each user registers with server 100, the user is asked to enter his or her username and stock ticker symbols, while on PC 30 the user is asked for his or her zip code, and to request particular sports league selections to limit the amount of sports information sent from server 100. All of this information may be completed on a website hosted by server 100. Once the user has logged into server 100, PC 30 sends a request to the CGI scripts on server 100 that gather data from server 100 for each user so that only a limited amount of information is sent from server 100 to PC computer 30. For example, a user's selected stock ticker symbols will control the stock ticker information, stock commentaries, and financial information sent from server 100 to PC 30. In addition, a user's zip code will control the weather information sent from server 100 to PC 30. Finally, a user's sports league information will control the amount of sports information that flows from server 100 to PC 30. The sports and weather information can either be stored in the RAM of the computer or on a file in the hard drive so that it does not need to be entered again in PC 30.

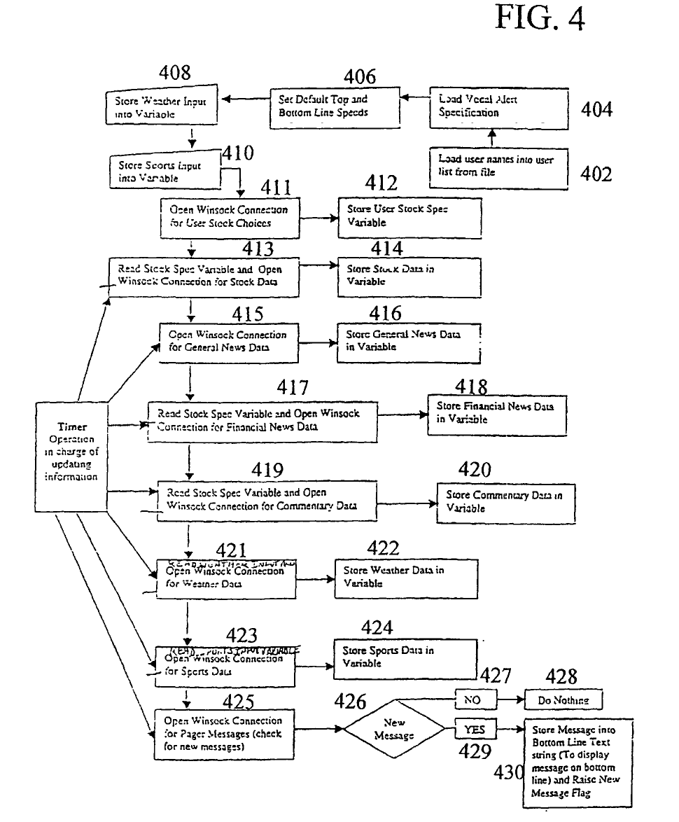

FIG. 4 shows a process for retrieving information from server 100 and sending it to PC 30. In step 402 PC 30 loads user names into its list from a file to log that user into server 100. Next, in step 404, PC 30 loads a vocal alert specification default, while in step 406, PC 30 sets a default for the top and bottom line speeds. Next, in step 408, PC 30 stores a weather input in the form of a zip code entered by the user into a variable on PC 30. In step 410, PC 30 stores a sports input such as a sports league selection into a variable in PC 30.

Next, in step 411, PC 30 opens a socket connection for user stock choices while in step 412, these user stock specifications are stored into a variable on PC 30. In step 413, PC 30 reads the stock specification variable and opens a socket connection to the CGI script on server 100 using this variable to retrieve stock data. Next, in step 414 this user stock data is stored into a variable. In step 415, PC 30 opens a socket connection to a CGI script on server 100 using a variable to receive general news data, while storing this data in a variable in PC 30 in step 416. Next, in step 417, PC 30 reads the stock specification variable and opens a socket connection to a CGI script on server 100 using a variable to request Financial News Data based upon this stock specification while storing this financial news data into a variable in step 418. In step 419, PC computer 30 reads the stock specifications and opens a socket connection to the CGI script on server 100 using the variable to receive for commentary data based upon this stock specification. In step 420 this commentary data is stored into a variable on PC 30.

In step 421 PC 30 reads the weather input variable in the form of a zip code and opens a socket connection to the CGI script on server 100 using a variable to request weather data. Next, in step 422 this weather data is stored into a variable on PC 30. In step 423, PC 30 reads the sports input variable and opens a socket connection to the CGI script on server 100 using this variable to request sports data. Next, PC 30 downloads and stores this data into a variable. Next, in step 425 PC 30 reads the username and opens a socket connection with the CGI script on server 100 using the username to receive pager messages, and checks for this message in step 426. In step 427, PC 30 detects if there are no new messages and proceeds to step 428 if this action occurs. Alternatively, in step 429, if the answer is yes, then PC 30 proceeds to store messages into the bottom line text string tD display a message on the bottom line and raise a new message flag.

Each variable is shared as a string of information in the form of ASCII text on PC 30. This ASCII text is next transformed into a serial signal and sent through a serial port on PC computer 30. This serial signal is then transmitted over serial cable 16 into serial interface 20. Serial interface 20, receives this information so that processor 50 next transforms the serial signal into a viewable signal such as a parallel signal for viewing on display screen 12.

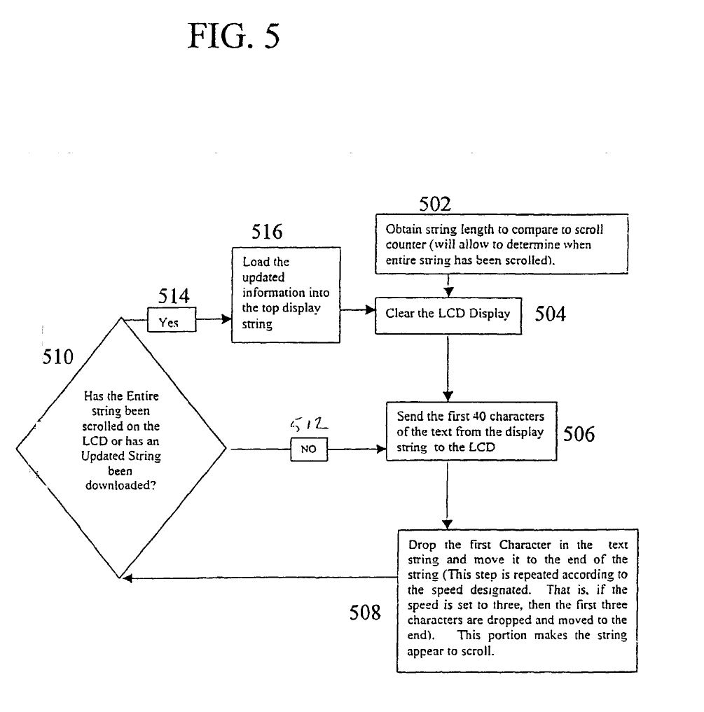

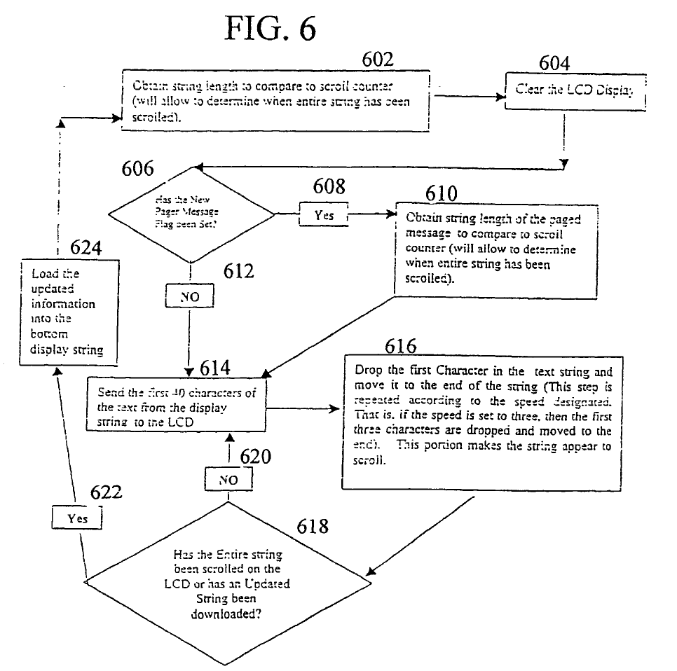

Display screen 12 can display at least two lines of streaming information. FIG. 5 shows the process for controlling the content and flow of information across a top line of display screen 12. For example, in step 502, PC 30 obtains the string length to compare to the scroll counter, which will allow PC 30 to determine when the entire string has been scrolled. In step 504, PC 30 clears the LCD display. In step 506, PC 30 sends the first 40 characters of the text form of the display string to the LCD.

Next, in step 508, PC 30 drops the first character in the next displayed text string and moves it to the end of that string. If the top line was reading a series of strings, the first character in the first string would become the last character in the next string. Display screen 12 repeatedly flashes with an updated string each 350 milliseconds so that these strings give a user the appearance of an endless scrolling string. In addition, in this step, PC 30 shifts the text string the number of spaces equal to the speed chosen. Therefore, the user can select a particular speed by touching either switch 47 or 48 to either increase or decrease the speed of the letters accordingly.

Finally, in step 510 PC 30 determines whether the entire string has been scrolled on display screen 12 by comparing the scroll counter with the string length. If the entire string has not been scrolled, then in step 512, the process returns to step 506 to resend the text to display screen 12. However, if the entire string has been scrolled, then the process in step 514 proceeds to step 516 to load the updated information into the top display string. This process continues as an endless loop so that text information sent to display screen 12 is shown as an endless scrolling loop.

The process for controlling the display of information on the bottom line differs from that of the top line. For example, the bottom line is also designed to display any pager messages sent to display screen 12 from server 100. Therefore, the process for displaying information on a bottom line starts with step 602, where PC 30 obtains the string length to compare the string counter, next in step 604, PC 30 clears the LCD display. Next, in step 606 PC 30 ascertains whether a new pager message has been sent. Next, if the pager message flag was sent, then in step 608 PC 30 registers this result and proceeds to step 610 wherein PC 30 obtains a string length of the paged message to compare this message to the scroll counter. This step will determine when the entire string has been scrolled. Next, if the entire string has beer. scrolled, or if in step 612 there were no new messages sent, then PC 30 proceeds to step 614. In step 614, PC 30 sends the first 40 characters of the text from the display string to the LCD. Next, in step 616, PC 30 drops at least the first character in the text string and moves it to the end of the string. Thus, if the speed is set to three, then with each new string, the first three characters are dropped and moved to the end. This set of instructions makes the string appear to scroll.

Next, in step 618, PC 30 ascertains whether the entire string has been scrolled on the display screen 12 by comparing the scroll counter to the string length to ascertain whether an updated string has been downloaded. If an updated string has not been downloaded, then PC 30 proceeds in step 620 back to step 614. However, if an updated string has been downloaded, or if the entire string has been scrolled, then in step 622 PC 30 proceeds to step 624 wherein the updated information is loaded into the bottom display string. Next, PC 30 proceeds back to step 602, to start the loop again. Thus, PC 30 obtains the string length to compare this length to scroll the counter. Once the string length has been determined, PC 30 can determine when the entire string length has been scrolled.

In each of these lines, an input from switch pad 40 can change the type of text information streaming on each line. In every cycle of the switch pad function, a check is performed to identify the depression of a switch to change a top or bottom a line of text. Each depression will call for the display of a different text string. If no new string is chosen, the subroutine will continue to poll the switch pad for additional entries.

FIG. 7 shows a first embodiment of an outer design for information display device 10. The electronic components of device 10 are disposed within an L-shaped housing 112 having a lateral section 112′ connected to cable 17, and a face section 112″ extending substantially perpendicular to lateral section 112′.

Extending out of a front face 115 of housing 112 and as shown in FIGS. 1 and 2, are switches 41, 42, 47 and 48 which allow the user to adjust the speed and the type of display shown on display screen 12.

Housing 112 is L-shaped to allow device 10 to sit on top of computer monitor, a shelf, a desk, a counter top or any other substantially horizontal platform. With this L-shaped design, device 10 could be placed on an edge of a horizontal surface with lateral section 112′ extending back on this surface and face section 112″ extending down in front of this surface. In this position, display screen 12 extends along a substantially vertical plane so that a user could comfortably view display screen 12 at eye level.

Device 10 could also be placed on a substantially horizontal surface below eye level so that face section 112″ sits on top of this surface while lateral section 112′ extends back and down towards this horizontal surface. In this second position, display screen 12 faces up towards a user's view. When device 10 is in this position, the angle of display screen 12 can be adjusted so that a user can comfortably view display screen 12.

FIG. 8 shows a front view of device 10 showing switches 41, 42, 47, and 48 and a front face of display screen 12. Essentially this view is substantially similar to the view that a user would see when reviewing information on display screen 12. This front view shows a simple yet easy to manage display device 10 that can be easily viewed by a user.

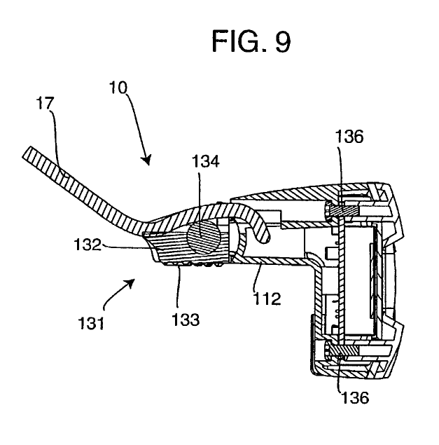

FIG. 9 shows a cross-sectional side view of device 10 showing cable 17 extending into a back region of housing 112. Below cable 17 is a counterweight 131 comprising a base 132 and a bar 134 coupled to counterweight base 132. Counterweight base 132 is necessary to balance against the weight of device 10 along 30 face region 112″. If device 10 was placed along an edge of a substantially horizontal surface, the weight of the components along face region 112″ would cause device 10 to pitch over this edge. Counterweight base 132 contains grip bottom 133 so that device 10 can be securely placed on top of a surface. Bar 134 is rotatably coupled to housing 112 so that a user can rotate counterweight 131 against housing 112 to adjust the viewing angle for display screen 12. There are also a series of counter sunk screws 136 which are designed to hold the components of device 10 together.

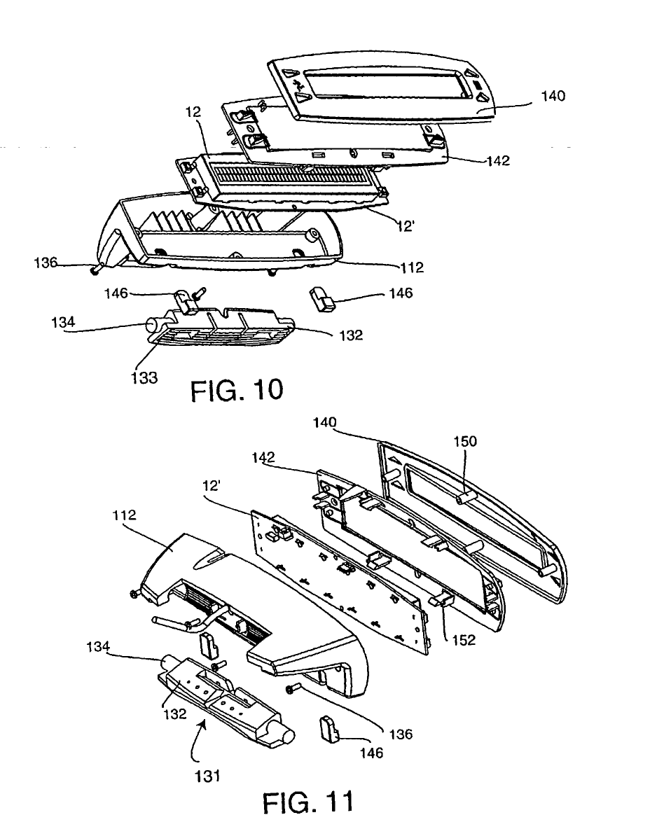

FIGS. 10 and 11 show an exploded front perspective view and an exploded back perspective view of device 10. As shown in FIG. 10, there is a face plate 140, a switch plate 142 disposed behind face plate 140 and a display plate 12′ for holding display screen 12, all coupled into housing 112. Screws 136 are used to couple these plates and the housing together while a set of clips 146 are used to secure counterweight base 132 and bar 134 into housing 112. FIG. 11 shows a back view of these plates wherein face plate 140 has a series of screw holes 150 extending back from face plate 140 wherein these screw holes 150 are designed to receive screws 136. In addition, there are also shown a series of clips 152, wherein these clips 152 clip switch plate 142 into housing 112.

Thus, FIGS. 10 and 11 show how device 10 can be easily assembled using pre molded plastic parts and a series of screws 136 to couple these parts together. Essentially, display plate 12′ can be inserted into housing 12 first, followed by switch plate 142 which fits over display plate 12′. Next, front plate 140 fits over switch plate 142 and is then secured thereto via screws 136 inserting into a back end of housing 112.

Accordingly, while several embodiments of the present invention have been shown and described, it is to be understood that many changes and modifications may be made thereunto without departing from the spirit and scope of the invention as defined in the appended claims.

What is claimed is:

1. An electronic information retrieval device for retrieving information sent from a computer comprising:
a) at least one additional display for displaying information sent from the computer;
b) an interface connected to said display, said interface comprising:
i) at least one switch pad interface having a series of switches;
ii) at least one connecting cable for connecting said interface to said display at one end and said interface to the computer at another end;
iii) at least one processor for translating a signal from said cable into displayable information on said display; and
iii) at least one power supply;
wherein said interface connects to the computer so that the computer sends information to said interface to process and send said information to said display so that said information is displayed as scrolling text on said display.

2. The device as claimed in claim 1, wherein said at least one connecting cable contains at least four pins for connecting said interface to the computer.

3. The device as claimed in claim 1, wherein said at least one switch pad includes switches selected from the group consisting of: a top line change switch, a bottom line change switch, a clear paged messages switch, a contrast up switch, a contrast down switch, and a backlight on or off switch.

4. The device as claimed in claim 3, wherein said switches in said switch pad are in a four by three matrix.

5. The device as claimed in claim 3, wherein said switches in said switch pad are in a series of one by three matrices.

6. The device as claimed in claim 1, further comprising at least one data transmitter for transforming information in said signal into a radio frequency signal.

7. The device as claimed in claim 1, further comprising at least one data receiver for receiving information sent in radio frequency (FM) waves and transforming said information into said signal for displaying on said display.

8. The device as claimed in claim 1, wherein said information comprises stock quotes.

9. The device as claimed in claim 1, wherein said information is selected from the group consisting of: stock quotes, weather information, news, commentaries, financial information, sports news such as headlines and scores, and personal messages.

10. The device as claimed in claim 1, wherein said display displays at least two lines of information.

11. The device as claimed in claim 1, wherein said display displays no more than three lines of information.

12. The device as claimed in claim 1, wherein said display displays said information without storing said information in said interface.

13. A method for retrieving information from a computer network and displaying this information on a remote device comprising the steps of:
a) registering a user on a remote computer connected to said computer network;
b) presenting a data form to said user on said remote computer so that the user can request different groups of information for display on the remote device.
c) retrieving said groups of information listed in said data form from the computer network;
d) presenting said groups of information on a remote display device; and
e) repeatedly updating said groups of information from said computer network on said display.

14. The method as in claim 13, wherein said step of continuously updating said groups of information is based upon a series of timers for polling said groups of information sent from said computer network.

15. The method as in claim 13, wherein said step of presenting said groups of information on a remote display device includes presenting stock ticker information.

16. The method as in claim 13, wherein said step of presenting said groups of information on said remote display device includes presenting sports scores, weather information, any form of news, and commentary.

17. The method as in claim 13, wherein said step of presenting said groups of information on said remote display device includes displaying at least two lines of data.

18. The method as claimed in claim 13, wherein said step of presenting said data on a remote display device occurs without entering said data into memory on said remote display device.

19. The method as claimed in claim 13, further comprising the step of displaying two lines of information on said display.

20. The method as claimed in claim 19, wherein said step of displaying two lines of information includes displaying a first line of stock ticker information and displaying a second line of information includes displaying financial news information relating to said first line of stock ticker information.

21. The method as claimed in claim 19, wherein said step of displaying two lines of information includes displaying a top line of information and a bottom line of information wherein said bottom line of information displays pager messages.

22. The method as claimed in claim 13, wherein said step of presenting said groups of information on a remote display device includes scrolling said information across said display in a repeatable string.

23. The method as claimed in claim 22, wherein said step of presenting said groups of information includes presenting said groups of information in a series of 40 character strings.

24. The method as claimed in claim 23, wherein said step of presenting said groups of information via scrolling includes dropping a first character from a first string and moving it to the end of at least one additional string so that said first character becomes the last character on said at least one additional string.

25. An electronic information retrieval device for retrieving information sent from a computer comprising:
a) a substantially L-shaped housing;
b) at least one display disposed in said substantially L-shaped housing for displaying information sent from the computer;
c) an interface connected to said display, said interface comprising:
i) at least one switch pad interface having a series of switches;
ii) at least one connecting cable for connecting said interface to said display at one end and said interface to the computer at another end;
iii) at least one processor for translating a signal from said cable into displayable information on said display; and
iii) at least one power supply;
wherein said interface connects to the computer so that the computer sends information to said interface to process and send said information to said display so that said information is displayed as scrolling text on said display.

26. The device as in claim 25, further comprising a counter weight coupled to said housing wherein when said housing is placed on an edge of a substantially horizontal surface, said counter weight balances against a weight of said display and said interface.

27. The device as in claim 25, wherein said counter weight further comprises a grip bottom so that when said housing is placed on a substantially horizontal surface said housing remains substantially stationary on said substantially horizontal surface.

28. The device as in claim 26, wherein said counter weight comprises a bar, and a base, wherein said bar is rotatably coupled to said housing so that said counter weight can be adjusted in said housing for adjusting a viewing angle of said at least one display when said housing is placed on said substantially horizontal surface.

29. The device as in claim 28 further comprising:
a display plate for holding said at least one display;
a switch pad plate for holding said at least one switch pad;
a face plate for covering said switch pad plate; and
a series of screws, wherein said display plate, said switch pad plate and said face plate are secured to said housing via said series of screws with said display plate being inserted into said housing, said switch pad plate inserting around said display plate and said face plate inserting over said switch pad plate and being secured thereto via said screws.

30. A monitor comprising:
a) a L-shaped housing; and
b) a display being disposed in said housing.

31. The monitor as in claim 30, further comprising a counter weight coupled to said housing said counter weight for balancing a weight of said housing against a weight of said display.

32. The monitor as in claim 31, wherein said counter weight comprises a base, and a bar coupled to said base.

33. The monitor as in claim 32, wherein said bar is rotatably coupled to said housing so that when said housing is placed on a substantially horizontal surface, said counter weight can be adjusted against said housing to alter a viewing angle on said display.
